(19) United States
(12) Patent Application Publication
(10) Pub. No.: US 2010/0145872 A1
(43) Pub. Date: Jun. 10, 2010

(54) SERVER AND METHOD FOR MANAGING HEALTH CLUB

(75) Inventors: Miok CHAE, Daejeon-city (KR); Dongoh KANG, Daejeon-city (KR); Jeunwoo LEE, Daejeon-city (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, Daejeon-city (KR)

(21) Appl. No.: 12/631,997

(22) Filed: Dec. 7, 2009

(30) Foreign Application Priority Data
Dec. 8, 2008 (KR) 10-2008-0124134
Oct. 29, 2009 (KR) 10-2009-0103666

(51) Int. Cl. G06Q 50/00; G06Q 99/00; G06Q 10/00; G06F 3/048; G06F 9/455; G06F 15/16

(52) U.S. Cl. 705/346; 705/1.1; 705/347; 715/810; 718/1; 709/203

(57) ABSTRACT

A method for managing a health club according to the present invention includes: receiving member information from mobile terminals of users in a server that is connected to monitors each corresponding to a plurality of health equipments in a wired or wireless manner; setting the monitors to be allocated to the users, which are authenticated as a member, among the monitors by the server; generating a virtual machine that connects between the set monitors and the mobile terminals; and providing contents requested by the users through the set monitors using the virtual machine.

### RELATED APPLICATIONS

The present application claims priority to Korean Patent Application Serial Number 10-2008-0124134, filed on Dec. 8, 2008 and Korean Patent Application Serial Number 10-2009-0103666, filed on Oct. 29, 2009, the entirety of which are hereby incorporated by reference.

### BACKGROUND OF THE INVENTION

1. Field of the Invention

The present invention relates to a method and server for managing a health club, and more specifically, to a method and server for managing a health club using an on-demand virtual system technology that configures and provides a virtual system using various input and output apparatus or portable apparatus that can be frequently found around us.

2. Description of the Related Art

A Ubiquitous environment is now possible due to the development of a wired and wireless communication technology and various input and output apparatuses and U-computing devices that are scattered around us. Various technologies have been applied to the ubiquitous environment. In particular, an on-demand virtual system technology recognizes various input and output apparatuses, intelligent terminals, personal digital assistants, and u-computing devices, which are scattered around users, as virtual functional resources and integrates, and manages, and combines these functional resources as desired according to a demand of a user to provide the virtual computing environment.

The on-demand virtual system technology has been actively studied based on a virtualization technology that is focused as a core technology for utility computing or cloud computing, various device linking technologies in the field of a home network, etc.

Meanwhile, a running machine, which is the most frequently used exercise equipment at the health club by people, has a TV receiver or monitor that is mounted on a supporter installed in front of the running machine or attached to the running machine in an attachment manner in order to solve the boredom due to repetitive motions in a confined space. The user selects his/her desired channel by a remote controller or a manual operation to watch TV. Further, the user plays desired music or moving picture using the input and output apparatuses such as a computer keyboard, a mouse, etc., and takes exercise while appreciating them.

### SUMMARY OF THE INVENTION

When a TV is mounted on the running machine, its use is relatively convenient. However, the user can only select the channels for information lopsidedly sent out from a broadcasting station. Therefore, there is a limitation in that various services cannot be provided to the users. Meanwhile, in the case of a computer, more various services can be provided to the users, but there are problems in that it is difficult to mount a relatively expensive computer on each running machine and it is inconvenient to operate and manage the computer.

Therefore, the present invention proposes to solve the above-mentioned problems in the related art. It is an object of the present invention to provide an apparatus and method for managing a health club using an on-demand virtual system technology that can configure a virtual system for each user, including monitors and portable apparatuses carried by the users, and supply customized services according to the recognized user information by connecting the monitors to the server, allowing the users to select the monitors by a convenient selecting method, and accessing the users to the server by authentication apparatuses and portable apparatuses in which personal information is stored, without mounting separate TVs or computers for each exercise equipment that can continuously enjoy exercise in a fixed place like a running machine or a cycling machine using the on-demand virtual system technology.

In order to achieve the above object, a method for managing a health club according to the present invention includes: receiving member information from mobile terminals of users in a server that is connected to monitors each corresponding to a plurality of health equipments in a wired or wireless manner; setting the monitors to be allocated to the users, which are authenticated as a member, among the monitors by the server; generating a virtual machine that connects between the set monitors and the mobile terminals; and providing contents requested by the users through the set monitors using the virtual machine.

Preferably, setting the monitors is setting the monitors selected by the users using the mobile terminals to be allocated to the users.

Preferably, setting the monitors is setting the corresponding monitors be allocated to the users when the power supplies of the corresponding monitors are turned-on by the users that are authenticated as a member using the mobile terminals

Preferably, the generating the virtual machine connects the corresponding monitors and the mobile terminals by the turn-on operation of the set monitors.

Preferably, the member information includes preference information for providing contents and the providing the contents determines the contents requested by the users based on the preference information.

Preferably, the providing the contents includes allowing the server to display menus for selecting the contents on the monitors and provides predetermined recommendation contents when the users do not select the contents using the mobile terminals.

Preferably, the contents include at least one service of voice, moving picture, broadcasting, and health information.

Preferably, the method for managing a health club further includes allowing the server to manage the actual results of health club use of the corresponding users based on the information input and output by the users through the mobile terminals.

Meanwhile, a server for managing a health club according to the embodiment of the present invention includes: a server communication unit that is connected to monitors each corresponding to a plurality of health equipments in a wired or wireless manner; a virtual machine generator that receives member information from mobile terminals of users to set the monitors to be allocated to the users, which are authenticated as a member, among the monitors and generates a virtual machine that connects between the set monitors and the mobile terminals; and a contents providing unit that provides contents requested by the users through the set monitors using the virtual machine.

Preferably, the virtual machine generator sets the monitors selected by the users as the monitors to be allocated to the users by using the mobile terminals.

Preferably, the virtual machine generator sets the corresponding monitors as the monitors to be allocated to the users when the power supplies of the corresponding monitors are turned-on by the users that are authenticated as a member using the mobile terminals.

Preferably, the virtual machine generator connects the corresponding monitors and the mobile terminals by the turn-on operation of the set monitors.

Preferably, the member information includes preference information for providing contents and the contents providing unit determines the contents requested by the users based on the preference information.

Preferably, the contents providing unit displays menus for selecting the contents on the monitor and then provides predetermined recommendation contents when the users do not select the contents using the mobile terminals.

Preferably, the contents providing unit manages the actual results of health club use of the corresponding users based on the information input and output by the users through the mobile terminals.

As described in detail, the present invention can provide a good quality of services to the users while minimizing the intervention of managers and significantly save the initial build-up costs of the system.

Further, the present invention can provide a good quality of customized services to the users of the health club and significantly save costs and efforts to manage the system during the operation.

In addition, the customized services can be provided according to the tendencies and preferences of the users.

### BRIEF DESCRIPTION OF THE DRAWINGS

FIG. 1 is a diagram showing a schematic configuration of a system to which a method for managing a health club according to an embodiment of the present invention is applied;

FIG. 2 is a flow chart of the method for managing a health club according to the embodiment of the present invention;

FIG. 3 is a diagram showing a configuration of a server for managing a health club according to an embodiment of the present invention shown in FIG. 1;

FIG. 4 is a diagram showing a configuration of a virtual machine client included in a mobile terminal of FIG. 1;

FIG. 5 is an exemplified diagram showing a configuration of an adaptor of FIG. 1; and

FIG. 6 is a diagram showing one example of the method for managing a health club according to the embodiment of the present invention.

### DETAILED DESCRIPTION OF THE PREFERRED EMBODIMENTS

Hereinafter, exemplary embodiments of the present invention will be described with reference to the accompanying drawings.

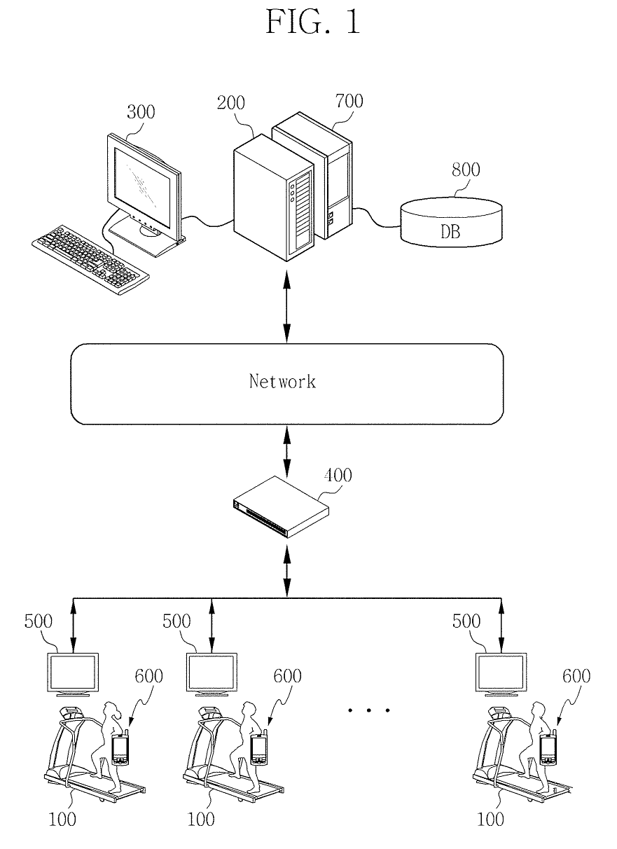

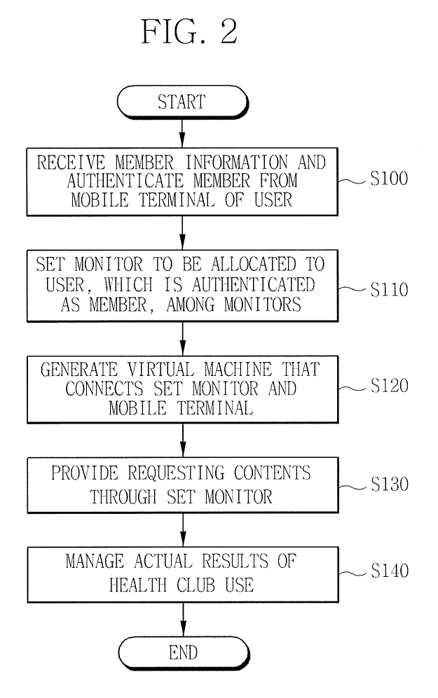

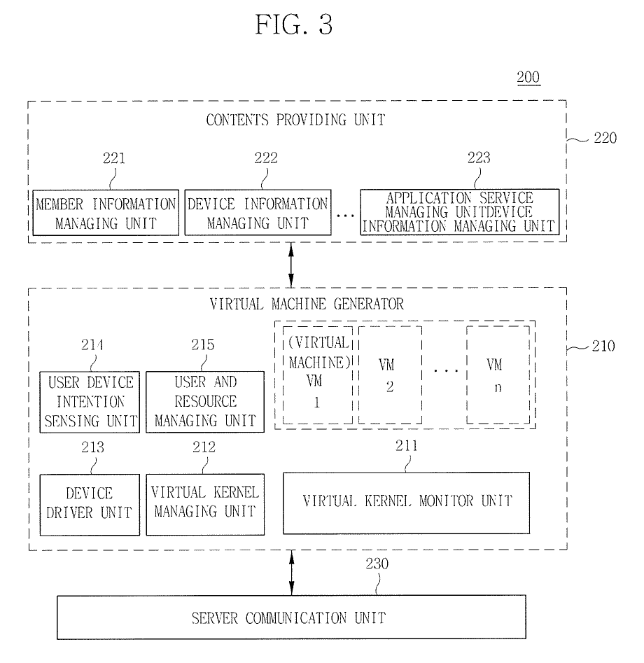

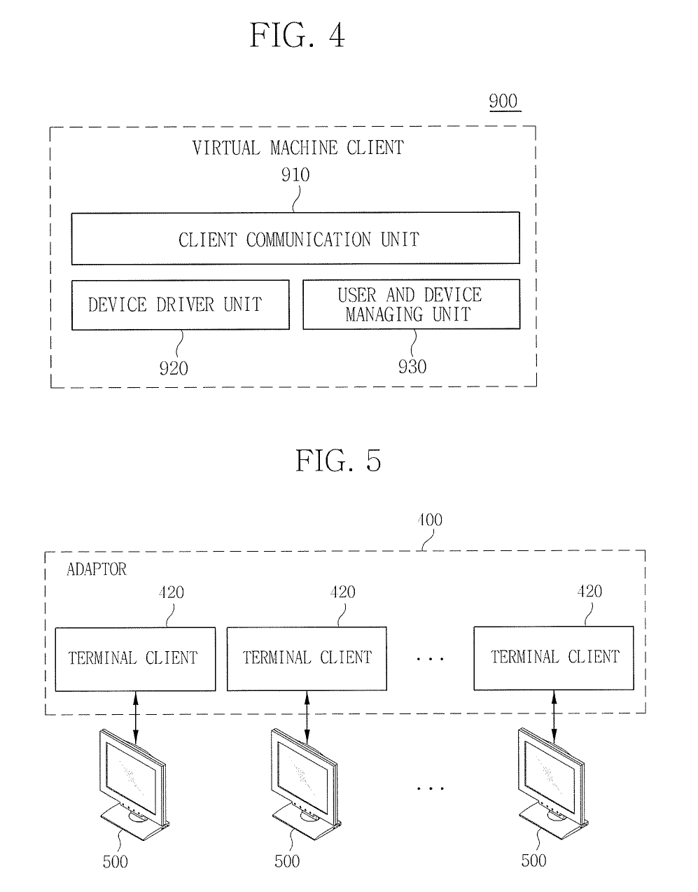

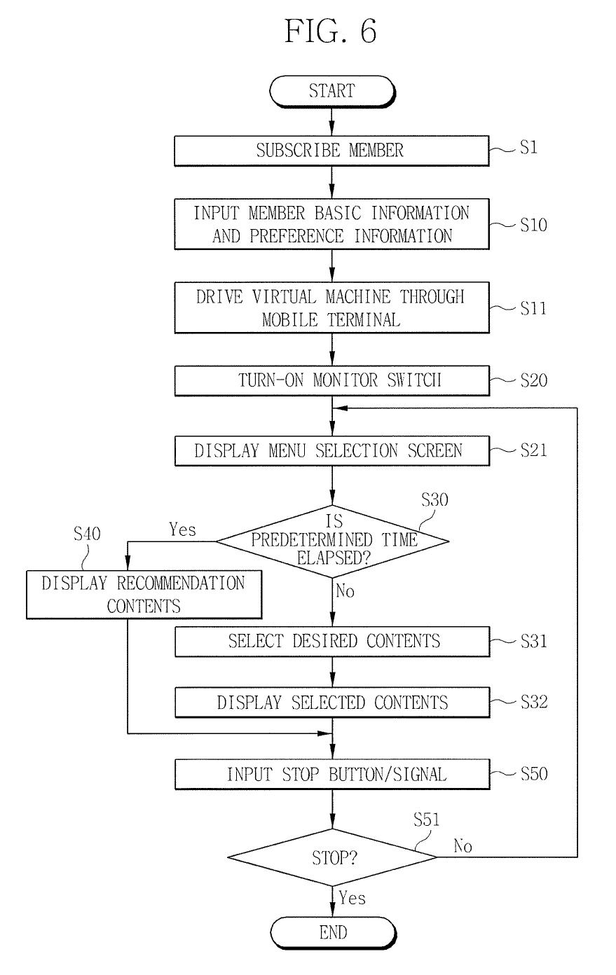

FIG. 1 is a diagram showing a schematic configuration of a system to which a method for managing a health club according to an embodiment of the present invention is applied, FIG. 2 is a flow chart of the method for managing a health club according to the embodiment of the present invention, FIG. 3 is a diagram showing a configuration of a server for managing a health club according to an embodiment of the present invention shown in FIG. 1, FIG. 4 is a diagram showing a configuration of a virtual machine client included in a mobile terminal of FIG. 1, FIG. 5 is an exemplified diagram showing a configuration of an adaptor of FIG. 1, and FIG. 6 is a diagram showing one example of the method for managing a health club according to the embodiment of the present invention.

Referring to FIG. 1, a system to which a method for managing a health club according to an embodiment of the present invention is applied is configured to include: monitors 500 each corresponding to a plurality of exercise equipments 100 that are mounted in a specific place; a server 200 (a server for managing a health club of the present invention is considered to be the same as a server) that is connected to the monitors 500 in a wired or wireless manner and provides a member authentication service to the corresponding monitors 500 at the time of using the corresponding exercise equipments 100 among the plurality exercise equipments 100 using a virtual machine (for example, a virtual system that is configured using various input and output apparatuses or portable apparatuses that are scattered around us, and the like); and mobile terminals 600 that are connected to the server 200 in a wired or wireless manner and transmits and receives information for the member authentication service.

In addition, the present invention may be configured to include a console 300 for a manager that manages the server, an adaptor 400 that is configured to connect the plurality of monitors 500 to the server 200 in a wired and wireless manner, a database 800 that stores member information, various contents, etc., and a portal server 700 that is connected to the server 200 through a wired and wireless communication network and manages data for the member authentication service, but is not limited thereto.

Herein, the portal server 700 is connected to internal and external communication networks and shares the server 200 and the database 800 to support the inquiry and modification of the member information, the addition and deletion of contents, etc. For example, the users can inquire and modify member basic information, preference information inside the health club as well as outside the health club and can upload contents that they wish to watch while exercising.

The database 800 stores various contents, etc., necessary for the member information, the device information, and the member authentication service of the health club. The database 800 may be configured to access materials according to the user access authority to the server 200 and the portal server 700.

In the present invention, the exercise equipment 100 means the exercise equipment 100 that can continuously enjoy exercise in a fixed place like a running machine and a cycling machine. The console 300 for a manager includes a keyboard, a mouse, a monitor, etc., and is connected to a server 200 directly or through a communication network.

Referring to FIG. 2, a method for managing a health club according to the present invention includes: receiving membership information from mobile terminals of users in a server that is connected to monitors each corresponding to a plurality of health equipments (exercise equipments) in a wired or wireless manner (S100); setting the monitors to be allocated to the users, which are authenticated as a member, among the monitors by the server (S110); generating a virtual machine that connects between the set monitors and the mobile terminals (S120); and providing contents requested by the users through the set monitors using the virtual machine (S130). Further, the method for managing a health club further includes allowing the server to manage the actual results of health club use of the corresponding users based on the information input and output by the users through the mobile terminals (S140).

As described above, the present invention connects the server 200 and the monitors 500 and the user selects the monitors 500 by a convenient selection method. The user accesses the server 200 using the mobile terminals 600 that provide functions of the user authentication, a virtual mouse, or a virtual keyboard driver. Thereby, the server 200 configures the virtual machine for the user and provides the high-quality customized services according to the recognized user information. As such, the system according to the method for managing the health club according to the embodiment of the present invention does not require to mount separate TVs or computers on the exercise equipments that can continuously enjoy in the fixed places like a running machine.

By the system configured as above, the initial build-up costs of the health club facility are very inexpensive, very less costs and efforts to manage the system during the operation are required, and the customized services can be easily provided according to the tendency and preference of the users, as compared to the related art.

Describing in more detail, as shown in FIG. 3, the server 200 to which the method for managing a health club is configured to include a server communication unit 230, a virtual machine generator 210, and a contents providing unit 220.

The server communication unit 230 is connected to the monitors 500 each corresponding to the plurality health equipments in a wired and wireless manner. The virtual machine generator 210 receives the member information from the mobile terminal 600 of the user to set the monitors 500 to be allocated to the users, which are authenticated as a member, among the monitors 500 and generates the virtual machine that connects the set monitors 500 and the mobile terminals 600. The contents providing unit 220 provides contents requested by the users through the set monitors 500 using the virtual machine. Thereby, the server 200 provides the member authentication service using the virtual machine. In the present invention, the server 200 can be implemented by hardware apparatuses such as PC or workstation or programs.

Herein, the virtual machine generator 210 recognizes the mobile terminals 600 (for example, various input and output apparatuses, intelligent terminals, personal digital assistants, u-computing devices, etc., that are scattered around the users) as the virtual function resources and integrates and manages them and combines these functional resources as desired according to the request of the users to provide the virtual computing environment, that is, the virtual machine.

In addition, the contents providing unit 220 provides the service, that is, the member authentication service that provides contents provided to the monitor 500 selected by the user. The contents include at least one service of voice, moving picture, broadcasting, and health information. In other words, the virtual machine generator 210 configures the virtual computing environment (virtual machine) between the monitor 500 and the mobile terminal 600 of the user. The contents providing unit 220 performs the member authentication through the confirmation of the member information in the state where the virtual computing environment is configured. The contents, that is, at least one service of voice, moving picture, broadcasting, and health information is provided on the corresponding monitor 500 according to the requesting information received by the selection of the member that is authenticated as a member.

In addition, the virtual machine generator 210 sets the monitor 500 selected by the user as the monitor to be allocated to the user using the mobile terminal 600. The virtual machine generator 210 provides the virtual machine (VM) through the member authentication by the mobile terminal 600 and connects the virtual machine to the monitor 500. The contents providing unit 220 displays contents on the monitor 500 according to the requesting information received from the mobile terminal 600. For example, when the user selects a number or a name that indicates the monitor mounted on the health equipment that he or she intends to use through the mobile terminal, the virtual machine generator 210 sets the corresponding monitor 500 as the monitor to be allocated to the user.

In addition, the virtual machine generator 210 sets the corresponding monitor 500 as the monitor 500 to be allocated to the user when the power supply of the corresponding monitor 500 is turned-on by the user that is authenticated as a member using the mobile terminal 600.

The work that the virtual machine generator 210 determines whether the power supply of the corresponding monitor 500 is turned-on by the user that is authenticated as a member using the mobile terminal 600 can be made in various manners, such as the position of the mobile terminal, the preference information as will be described below, etc. When the virtual machine generator 210 determines the monitor to be set based on the position of the mobile terminal, the user turns-on the power supply of the monitor mounted on the health equipment to be used through the mobile terminal 600. The virtual machine generator 210 grasps the position of the mobile terminal using a wired and wireless signal, etc., and when the user turns-on the power supply of neighboring monitor 500 based on the position of the mobile terminal, the virtual machine generator 210 can recognize the monitor 500 to set it as the monitor to be allocated to the user. The method of grasping the position of the mobile terminal is already known and therefore, the detailed description thereof will be omitted. Further, when the virtual machine generator 210 determines the monitor to be set based on the preference information, it receives data on the exercise equipments to be used by the user based on the preference information previously input through the mobile terminal 600. After the member is authenticated through the mobile terminal 600 based on the preference information and then the turn-on signal of the monitor 500 is received, the corresponding monitor is set as the monitor to be allocated to the user. The method for setting the monitor to be allocated can be variously changed and therefore, is not limited to the foregoing.

Preferably, the virtual machine generator 210 sets the corresponding monitor 50 as the monitor 500 to be allocated to the user when the power supply of the corresponding monitor 500 is turned-on by the user that is authenticated as a member using the mobile terminal 600.

Thereby, the contents providing unit 220 initiates the member authentication service using the virtual machine according to the turn-on of the monitor 500. For example, when the user uses a running machine in the health club, he or she authenticates a member through mobile terminal 600 in order to solve the boredom due to a repetitive motion in a confined space. When the monitor 500 is turned-on, contents are provided to the monitor 500 by the server 200 such that the user plays music or moving picture and can then take exercise while appreciating them.

Preferably, the server communication unit 230 receives the member information on the users and the preference information for providing contents from the mobile terminal 600. As a result, the contents providing unit 220 determines contents requested by the user based on the preference information and provides the contents. Preferably, the preference information includes data on contents that the user mainly wishes to receive, exercise equipments and corresponding monitors mainly used by the user, time mainly used by the user, etc. Thereby, the present invention can easily perform the member authentication service and the member management when the user, who is the member of the health club, uses the health club.

The server communication unit 230 can display menus for selecting contents on the corresponding monitor 500 and then, provide the predetermined recommendation contents when the user does not select contents using the mobile terminal 600.

Meanwhile, the virtual machine generator 210 is configured to include a virtual kernel monitor unit 211 that monitors a virtual kernel, a virtual kernel managing unit 212 that manages the virtual kernel, a device driver 213 that sets the corresponding resources, a user device intention sensing unit 214 that senses resources such as monitors selected by the user, a user and resource managing unit 215 that manages members and resources, and a server communication unit 216 that performs communication through a wired and wireless communication network. When the virtual machine generator 210 can be configured to build up the virtual machine (VM) that links each of the mobile terminals 600, which are authenticated as a member, with the corresponding monitors 600 used at the time of using the exercise equipments, any configurations can be allowed and therefore, the configuration of the virtual machine generator is not limited thereto.

The contents providing unit 220 is configured to include a member information managing unit 221 that manages information for member authentication, a device information managing unit 222 that manages device information of a monitor, a mobile terminal, etc., and an application service managing unit 223 that manages an application service such as menus, etc., and accesses a database 800 to manage information. When the contents providing unit 220 has a configuration that can perform the contents provision, the member management, etc., any configurations can be allowed and therefore, the configuration of the contents providing unit is not limited thereto.

In addition, as described above, the contents providing unit 220 can manage the actual results of the health club use of the corresponding user based on the information input and output by the user through the mobile terminal 600. As a result, the member of the health club can be managed without the separate system configuration.

Referring to FIG. 4, the mobile terminal includes the virtual machine that is built up between the monitor 500 and the mobile terminal 600 by the server 200 according to the present invention and a virtual machine client 900 that is connected to the network through the wired or wireless communication. In addition, the virtual machine client may be mounted on the adaptor 400 as will be described below.

The virtual machine client 900 is configured to include a client communication unit 910 that communicates with the server 200, a device driver unit 920 that sets a device, and a user and device managing unit 930 that manages a member and a device. The on-demand virtual system client 900 is operated being included in the adaptor 400 or the mobile terminal 600 and performs the data transmission and reception and other client inherent functions while communicating with the above-mentioned server 200. The virtual machine client 900 has a configuration that is connected with the above-mentioned virtual machine, which can be easily understood from the on-demand virtual system technology by those skilled in the art.

Referring to FIG. 5, the adaptor 400 connects the monitor 500 to the server 200. The adaptor 400 includes a hardware connection apparatus that connects the plurality of monitors 500 to the server 200 and the virtual machine client 900 is mounted on the operating system environment to generate and operate the terminal client 420 (for example, a client virtually implementing the monitor, etc.) for the monitor 500 For example, the fact that the monitor 500 plugs in the adaptor 400 is recognized in a plug and play manner, the terminal client 420 generates one client thread/process for the corresponding monitor 500 and receives device profile information from the monitor 500 and transmits it to the server 200. As a result, the corresponding monitor 500 and the mobile terminal 600 that is authenticated as a member are connected to the terminal client 420.

The monitor 500 including a switch that can turn-on/off the power supply is used and when the member starts exercise, he or she selects the desired monitor 500 by turning-on the monitor 500. Preferably, the monitor 500 is allocated to each exercise equipment 100.

The mobile terminal 600 is operated by mounting the virtual machine client 900 under the operating system environment that is supported by the terminal like the adaptor 400. The mobile terminal 600 stores a user inherent ID, a password, and other user preference information and provides the virtual device driver to provide the keyboard resource and mouse resource as the virtual functional resources. Therefore, the user can use the mobile terminal 600 carried by him or her as the input apparatus, instead of the mouse or the keyboard.

Hereinafter, the method for managing a health club according to the present invention will be described by way of example. In the present invention, the mobile terminal 600 should be mounted with the virtual machine client 900 in order for the user to register a member in the health club and receive services. Therefore, it will be described under the assumption that the virtual machine client 900 is mounted in the mobile terminal 600 of the member.

Referring first to FIG. 6, the server 200 receives the member subscription based on the information on the member input to the console 300 for a manager (S1). For example, the manager performs the user ID generation for the member and performs the member subscription according to assigning the user ID to the user.

Next, the server 200 stores the member basic information and the preference information for the member authentication service that is input to the console 300 for a manager or the mobile terminal 600 (S10). For example, the manager or the member input the member basic information, the preference information, etc., using the console 300 for a manager or the mobile terminal 600. The preference information is used as information for determining the types or contents of the services that are received while exercising.

Then, the mobile terminal 600 starts the virtual machine client 900, such that the following detailed steps are performed. First, the communication between the mobile terminal 600 and the server 200 is initiated and the mobile terminal 600 transmits the stored user authentication information and preference information to the server 200. The server 200 confirms that the user is the authenticated user and is in a standby state. Of course, when the member does not have the mobile terminal 600, he or she can replace it using the user log-in function in the console 300 for a manager that are carried by the manger. In this case, however, it is cumbersome to continuously play the recommendation contents or select contents in the console 300 for a manager every times.

Next, the server 200 initiates the member authentication service using the virtual machine according to the turn-on of the monitor 500 by the user (S20). For example, the user selects the desired monitor 500 through the operation of turning-on the monitor switch in front of the user desired exercise equipment 100, recognizes the monitor in the adaptor 400 attached to the monitor 500 by the above operation, and reads the corresponding profile information and transmits it to the server 200. The server 200 generates one new virtual machine (VM) and connects the mobile terminal 600 of the user authenticated in the virtual machine and the currently recognized monitor 500 as the input and output resource and executes the application programs for the health club member.

As described above, the work that the server 200 determines whether the power supply of the corresponding monitor 500 is turned-on by the user that is authenticated as a member using the mobile terminal 600 can be made in various manners, such as the position of the mobile terminal, the preference information as will be described below, etc. For example, the user turns-on the power supply of the monitor, which is mounted on the health equipment to be used, through the mobile terminal 600 of the user. As a result, the server 200 grasps the position of the mobile terminal 600 using a wired and wireless signal, etc., and when the user turns-on the power supply of neighboring monitor 500 based on the position of the mobile terminal, the server 200 can recognize the monitor 500 to set it as the monitor to be allocated to the user. Further, the server 200 receives data on exercise equipment to be used by the user based on the preference information previously input through the mobile terminal 600. After the member is authenticated through the mobile terminal 600 based on the preference information, the corresponding monitor 500 is set as the monitor to be allocated to the user when the turn-on signal of the monitor 500 is received.

Thereafter, the server 200 displays a menu selection screen on the monitor 500 (S21). For example, the application program initial screen for the member is output. Thereafter, when there is no input for a predetermined time (S30: Y), the server 200 provides the recommendation contents for the member (S40). For example, the server 200 displays the selected contents on the corresponding monitor 500 based on the preference analysis or rule, which are set by the user, at the time of the member subscription or through the portal server.

Then, the server 200 provides the selected contents through the mobile terminal 600 (S31, S32). For example, the user uses the mobile terminal 600 as the virtual functional resources, that is, the keyboard or the virtual mouse and can select such as contents using the mobile terminal 600 without mounting the separate keyboard or the mouse around the exercise equipments 100.

Finally, if the server 200 receives the predefined mouse/keyboard input signals (for example, stop, end, return, etc.) from the mobile terminal 600, it stops the corresponding contents and displays the menu selection screen (S50). For example, the user returns to the menu selection screen on the monitor 500 and can select an end or other contents menu.

Meanwhile, the server 200 provides the contents upon using the exercise equipment 100 in the above-mentioned manner and then, records the information on the exercise time of the member, the selected contents, etc., in the database (DB) 800 and releases the related resources and then ends the application programs. The contents recorded in the database 800 are used to select contents to be recommended later and manage the actual results of the health club member to provide other services. The user inquires the recorded information through the portal server or stores desired contents such as movie, music, video lecture, etc., at the outside, thereby making it possible to use them during exercise.

Although it is described that the server 200 of the present invention includes the virtual machine generator 210, the contents providing unit 220, and the server communication unit 230, each component can be configured in the form of one server or a terminal.

As described in detail, the present invention can provide a good quality of services to the users while minimizing the intervention of managers and significantly save the initial build-up costs of the system.

Further, the present invention can provide a good quality of customized services to the users of the health club and significantly save costs and efforts to manage the system during the operation.

In addition, the customized services can be provided according to the tendencies and preferences of the users.

The present invention is not limited to the foregoing embodiments, but the embodiments may be configured by selectively combining all the embodiments or some of the embodiments so that various modifications can be made.

What is claimed is:

1. A method for managing a health club, comprising:
receiving member information from mobile terminals of users by a server that is connected to monitors each corresponding to a plurality of health equipments in a wired or wireless manner;
setting the monitors to be allocated to the users, which are authenticated as a member, among the monitors by the server;
generating a virtual machine that connects the set monitors and the mobile terminals; and
providing contents requested by the users through the set monitors by using the virtual machine.

2. The method for managing a health club according to claim 1, wherein setting the monitors is setting the monitors selected by the users to be allocated to the users using the mobile terminals.

3. The method for managing a health club according to claim 1, wherein setting the monitors is setting the corresponding monitors to be allocated to the users when the power supplies of the corresponding monitors are turned-on by the users that are authenticated as a member using the mobile terminals.

4. The method for managing a health club according to claim 3, wherein generating the virtual machine connects the corresponding monitors and the mobile terminals by the turn-on operation of the set monitors.

5. The method for managing a health club according to claim 1, wherein the member information includes preference information for providing contents, and
providing the contents determines the contents requested by the users based on the preference information.

6. The method for managing a health club according to claim 5, wherein the providing the contents includes allowing the server to display menus for selecting the contents on the monitors, and provides predetermined recommendation contents when the users do not select the contents using the mobile terminals.

7. The method for managing a health club according to claim 1, wherein the contents include at least one of voice, moving picture, broadcasting, and health information.

8. The method for managing a health club according to claim 1, further comprising managing, by the server, the actual results of health club use of the corresponding users based on the information input and output by the users through the mobile terminals.

9. A server for managing a health club, comprising:
a server communication unit that is connected to monitors each corresponding to a plurality of health equipments in a wired or wireless manner;
a virtual machine generator that receives member information from mobile terminals of users to set the monitors to be allocated to the users, which are authenticated as a member, among the monitors and generates a virtual machine that connects between the set monitors and the mobile terminals; and
a contents providing unit that provides contents requested by the users through the set monitors using the virtual machine.

10. The server according to claim 9, wherein the virtual machine generator sets the monitors selected by the users as the monitors to be allocated to the users by using the mobile terminals.

11. The server according to claim 9, wherein the virtual machine generator sets the corresponding monitors as the monitors to be allocated to the users when the power supplies of the corresponding monitors are turned-on by the users that are authenticated as a member using the mobile terminals.

12. The server according to claim 11, wherein the virtual machine generator connects the corresponding monitors and the mobile terminals by the turn-on operation of the set monitors.

13. The server according to claim 9, wherein the member information includes preference information for providing contents, and
the contents providing unit determines the contents requested by the users based on the preference information.

14. The server according to claim 13, wherein the contents providing unit displays menus for selecting the contents on the monitor and then provides predetermined recommendation contents when the users do not select the contents using the mobile terminals.

15. The server according to claim 9, wherein the contents providing unit manages the actual results of health club use of the corresponding users based on the information input and output by the users through the mobile terminals.
